(19) United States
(12) Patent Application Publication
(10) Pub. No.: US 2012/0163127 A1
(43) Pub. Date: Jun. 28, 2012

(54) METHOD FOR MONITORING A VICINITY USING SEVERAL ACOUSTIC SENSORS

(76) Inventors: Christoph Gerdes, Munchen (DE); Joachim Hofer, Munchen (DE); Elmar Sommer, Munchen (DE)

(21) Appl. No.: 13/386,574

(22) PCT Filed: May 31, 2010
(86) PCT No.: PCT/EP2010/057518

§ 371 Date: Mar. 14, 2012

(30) Foreign Application Priority Data
Jul. 23, 2009 (DE) 10 2009 034 444.6

(51) Int. Cl. H04B 1/06

(52) U.S. Cl. 367/135

(57) ABSTRACT

A method for monitoring a vicinity using a plurality of acoustic sensors (1, 2, 3, 4), which form a decentralized net (N), in which the sensors (1, 2, 3, 4) communicate with one another, at least in part, wherein the respective sensors (1, 2, 3, 4) register acoustic signals based on noises in the vicinity, and reprocess the registered signals to conduct a situation recognition. According to the method, a respective sensor (1, 2, 3, 4) of at least some of the sensors (1, 2, 3, 4) accesses, via the decentralized net (N), the registered and/or reprocessed signals of one, or several, adjacent sensors (1, 2, 3, 4), and takes these signals into account for the situation recognition, wherein an adjacent sensor (1, 2, 3, 4) registers signals, which, at least in part, are based on the same noises as the ones registered by the respective sensor.

### CROSS-REFERENCE TO RELATED APPLICATIONS

This application is a U.S. National Stage Application of International Application No. PCT/EP2010/057518 filed May 31, 2010, which designates the United States of America, and claims priority to DE Patent Application No. 10 2009 034 444.6 filed Jul. 23, 2009. The contents of which are hereby incorporated by reference in their entirety.

### TECHNICAL FIELD

The invention relates to a method for monitoring a vicinity using a plurality of acoustic sensors and also to a corresponding acoustic sensor network.

### BACKGROUND

In order to recognize exceptional situations, such as panic or violence, or medical emergencies in public vicinities such as for example stations or sport stadiums, as a general rule optical sensors in the form of surveillance cameras are used nowadays. In this instance the monitoring of the vicinity is for the most part carried out manually by specialist security staff who view and evaluate the data from the optical sensors in a central control room. Since in the case of large vicinities there are a large number of data sources to monitor, under certain circumstances a long period of time may elapse before a critical situation is recognized. By the same token, an exceptional situation may under certain circumstances not be noticed at all due to human error.

In addition, automatic monitoring methods based on optical sensors with integrated situation recognition are known from the prior art. These methods have the disadvantage that the quality of the situation recognition is low in particular in the case when greater numbers of people are to be monitored.

### SUMMARY

According to various embodiments, an automatic method for monitoring a vicinity can be created which makes possible improved situation recognition.

According to an embodiment, in a method for monitoring a vicinity using a plurality of acoustic sensors, which form a decentralized network in which the sensors communicate with one another at least in part, the sensors each register acoustic signals which are based on noises in the vicinity, and reprocess the registered signals in order to conduct a situation recognition, a respective sensor of at least some of the sensors accesses, by way of the decentralized network, the registered and/or reprocessed signals from one or more adjacent sensors and takes these signals into account for the situation recognition, and an adjacent sensor registers signals which are based at least in part on the same noises as the signals registered by the respective sensor.

According to a further embodiment, the plurality of sensors may form a peer-to-peer network, whereby each sensor constitutes a peer in this network. According to a further embodiment, the plurality of sensors may form a wireless radio network, in particular an ad-hoc network, whereby the sensors each comprise a radio module for receiving and transmitting wireless signals in the radio network. According to a further embodiment, a respective sensor of at least some of the sensors may ascertain an adjacent sensor in accordance with one or more predefined adjacency criteria. According to a further embodiment, the predefined adjacency criterion or criteria can be given by the fact that two sensors are classed as adjacent if they are disposed in radio range of one another. According to a further embodiment, the adjacency criterion or criteria can be given by a spatial distance between sensors, whereby two sensors can be classed as adjacent if the spatial distance is less than or equal to a predetermined threshold, whereby the distances to at least some of other sensors in the decentralized network are known to a respective sensor of at least some of the sensors. According to a further embodiment, a respective sensor of at least some of the sensors may access the registered signals from the adjacent sensors and carries out a noise suppression by means of a correlation analysis of these signals and of the signals registered by said sensor. According to a further embodiment, a respective sensor of at least some of the sensors may reprocess the signals registered by said sensor in such a manner that it extracts one or more features from the registered signals, whereby with regard to the situation recognition the respective sensor takes into account the features extracted by said sensor and the features extracted by the adjacent sensors. According to a further embodiment, the extracted features can be based on one or more of the following variables:—the volume of the registered signals;—the volume distribution over the frequency of the registered signals;—the change in the volume over time for one or more frequencies of the registered signals. According to a further embodiment, a respective sensor of at least some of the sensors may use a rule-based decision model for situation recognition. According to a further embodiment, a respective sensor of at least some of the sensors may use a data-based model for situation recognition. According to a further embodiment, the data-based model may comprise a Hidden Markov model and/or a Gaussian mixture model and/or a support vector machine and/or a neural network. According to a further embodiment, in an initialization phase a respective sensor of at least some of the sensors may exchange the registered signals and/or the reprocessed signals with the adjacent sensors and ascertains a normal state on the basis of these signals. According to a further embodiment, the normal state can be represented by a statistical distribution of extracted features. According to a further embodiment, a respective sensor of at least some of the sensors may adapt the normal state during operation of the method depending on the signals registered by said sensor and the adjacent sensors. According to a further embodiment, one or more predetermined situations can be defined by way of predetermined deviations from the normal state.

According to another embodiment, an acoustic sensor network for monitoring a vicinity may comprise a plurality of acoustic sensors, which form a decentralized network in which the sensors can communicate with one another at least in part, whereby the sensors each comprise an acquisition unit for registering acoustic signals based on noises in the vicinity, and a processing unit for reprocessing the registered signals in order to conduct a situation recognition, whereby a respective sensor of at least some of the sensors is designed in such a manner that it accesses the registered and/or reprocessed signals from one or more adjacent sensors by way of a communication interface and takes these signals into account for the situation recognition, whereby an adjacent sensor registers signals which are based at least in part on the same noises as the signals registered by the respective sensor.

According to a further embodiment of the acoustic sensor network, the network can be designed in such a manner that a method as described above can be carried out in the sensor network.

According to yet another embodiment, an acoustic sensor for use in an acoustic sensor network as described above, may comprise an acquisition unit for registering acoustic signals based on noises in the vicinity, and a processing unit for reprocessing the registered signals in order to conduct a situation recognition, whereby the sensor is designed in such a manner that during operation of the sensor network it accesses the registered and/or reprocessed signals from one or more adjacent sensors by way of a communication interface and takes these signals into account for the situation recognition, whereby an adjacent sensor registers signals which are based at least in part on the same noises as the signals registered by the respective sensor.

### BRIEF DESCRIPTION OF THE DRAWINGS

An exemplary embodiment will be described in the following with reference to FIG. 1.

FIG. 1 shows a schematic illustration of a sensor network in which a variant of the method is carried out.

### DETAILED DESCRIPTION

The method according to various embodiments is based on acoustic monitoring of a vicinity using a plurality of sensors. In this instance the sensors form a decentralized network in which they communicate with one another at least in part. During operation of the method the respective sensors register acoustic signals which are based on noises in the vicinity. These registered signals are then reprocessed by the individual sensor in order to conduct a situation recognition, whereby corresponding conventional methods for acoustic situation recognition are already known.

The method according to various embodiments is characterized by the fact that a respective sensor of at least some of the sensors accesses, by way of the decentralized network, the registered and/or reprocessed signals from one or more adjacent sensors and takes these signals into account for the situation recognition. The individual sensors thus do not perform their situation recognition autonomously but also take into account the registered noise signals from adjacent sensors. In this instance, an adjacent sensor is understood to be a sensor which registers signals that are based at least in part on the same noises as the signals registered by the respective sensor. By taking into account corresponding signals from a plurality of adjacent sensors, the information for conducting the situation recognition is enhanced, with the result that the situation recognition of the individual sensor is improved. Furthermore, an efficient information exchange between the sensors is achieved by means of a decentralized network which does without a central management unit.

In accordance with the situation recognition, the respective sensor can then in a suitable manner recognize conspicuous soundscapes deviating from a norm. With regard to the recognition of a conspicuous situation, in an variant a corresponding report is conveyed to a central point by the respective sensor, whereupon a closer check can take place in order to ascertain whether an exceptional situation does in fact exist which requires appropriate countermeasures. Where applicable, on recognizing a situation deviating from the norm a sensor can additionally or alternatively output a noise signal locally, for example a suitable beeping through a loudspeaker installed in the sensor. In this manner, persons in the vicinity of the sensor are alerted directly to a potential exceptional situation.

In an embodiment of the method, the individual sensors communicate with one another by way of a peer-to-peer network, whereby each sensor constitutes a peer in this network. Already known peer-to-peer protocols, such as for example Chord, can be used for communication purposes in this instance. The use of a peer-to-peer network as a decentralized network in the method according to various embodiments offers special advantages because such networks prove to be very stable and can organize and configure themselves very efficiently. In particular, these networks can also react quickly to dynamic changes in the network, for example to the failure of a sensor or the addition of a sensor. In this manner, a method for acoustic monitoring of a vicinity is created which is robust and adapts dynamically to a change in the network.

A vicinity monitoring system which is particularly easy to install is accomplished in an embodiment in that a wireless radio network is formed by the plurality of sensors, whereby the sensors in this case each comprise a radio module for receiving and transmitting wireless signals in the radio network. In an embodiment, the radio network forms a so-called ad-hoc network which constitutes a meshed network that establishes and configures itself independently, as is also the case with peer-to-peer networks. Corresponding protocols and routing methods for ad-hoc networks are sufficiently known from the prior art in this instance.

As already explained above, a sensor is classed as adjacent with respect to a respective sensor if both sensors at least in part register the same noise signals. In this instance, in the method according to various embodiments corresponding adjacency criteria can be specified which provide the basis for ascertaining that one sensor is adjacent to another sensor. If a plurality of adjacency criteria is taken into account in the method according to various embodiments, two sensors will then only be classed as adjacent if all the adjacency criteria are satisfied. For example, during the development of a radio network the predefined adjacency criterion or criteria between the sensors can be given by the fact that two sensors are classed as adjacent if they are disposed in radio range of one another.

In a further embodiment, the adjacency criteria can alternatively or additionally be given by a spatial distance between the sensors, whereby two sensors are classed as adjacent if the spatial distance is less than or equal to a predetermined threshold. In this case, the distances to at least some of other sensors in the decentralized network must be known in a respective sensor. This information can be exchanged for example by sending information over the decentralized network between the individual sensors.

In an embodiment, a respective sensor of at least some of the sensors directly accesses the registered signals from the adjacent sensors and carries out a noise suppression by means of a correlation analysis of these signals and of the signals registered by said sensor. By this means, a particularly simple facility is provided for enhancing the noise signal to be analyzed and thereby achieving an associated enhanced situation recognition.

In an embodiment, a respective sensor of at least some of the sensors performs a reprocessing of the data registered by said sensor in such a manner that it extracts one or more features from the registered signals, whereby with regard to the situation recognition the respective sensor takes into account the features extracted by said sensor and moreover also the features extracted by the adjacent sensors. In this instance, extracted features can be based for example on the volume of the registered signals and/or the volume distribution over the frequency of the registered signals and/or the change in the volume over time for one or more frequencies of the registered signals. The recognition of situations on the basis of correspondingly extracted features is already known from the prior art in this instance. Henceforth the situation recognition of an individual sensor does not however take place only on the basis of the features extracted by said sensor itself but also on the basis of the features from other sensors.

A respective sensor can employ any desired, already known methods for situation recognition. In one variant, a respective sensor of at least some of the sensors uses a rule-based decision model. In this instance, predefined rules are given, on satisfaction of which a corresponding situation is then recognized. Such a rule can for example consist in the fact that an exceptional situation is recognized if a previously specified threshold for a volume level is exceeded. Additionally or alternatively, data-based models can also be used for situation recognition. Such models are learned or trained in advance using appropriate acoustic training data. Very good situation recognition is attained with data-based models. Different data-based models are known from the prior art which can also be employed in the method according to various embodiments, such as for example hidden Markov models and/or Gaussian mixture models and/or support vector machines and/or artificial neural networks.

In an embodiment, the training of the data-based model takes place in an initialization phase prior to the actual vicinity monitoring. In this initialization phase a respective sensor of at least some of the sensors exchanges the registered signals and/or the reprocessed signals with the adjacent sensors and ascertains a normal state on the basis of these signals. This normal state in particular constitutes a statistical distribution of features extracted correspondingly from the signals. In a variant, the data-based model is adapted continuously during operation of the method by means of the respective sensor depending on the acoustic signals registered by said sensor and the adjacent sensors. In this manner, a suitable adaptation of the situation recognition to changing soundscapes is ensured.

With regard to a situation recognition based on a data-based model with a correspondingly determined normal state, the situation recognition preferably takes place in such a manner that one or more predetermined situations are defined by way of predetermined deviations from the normal state. In this case, it is not necessary to train in advance an explicit sound event deviating from the norm.

In addition to the method described above, various embodiments also relate to an acoustic sensor network for monitoring a vicinity, whereby said sensor network comprises a plurality of acoustic sensors which form a decentralized network in which the sensors communicate with one another at least in part. In this instance, the sensors each comprise an acquisition unit, for example in the form of one or more microphones (in particular in combination with an analog-to-digital converter), whereby acoustic signals based on noises in the vicinity are registered by this acquisition unit. Furthermore, the respective sensor contains a processing unit for reprocessing the registered signals in order to conduct a corresponding situation recognition. The acoustic sensor network is distinguished by the fact that a respective sensor of at least some of the sensors is designed in such a manner that it accesses the registered and/or reprocessed signals from one or more adjacent sensors by way of a communication interface, for example in the form of a corresponding radio module, and takes these signals into account for the situation recognition, whereby an adjacent sensor registers signals which are based at least in part on the same noises as the signals registered by the respective sensor.

The acoustic sensor network is preferably designed in such a manner that any variant of the method described above can be carried out with the sensor network.

Other embodiments furthermore relate to an acoustic sensor for use in the acoustic sensor network described above. The sensor comprises an acquisition unit for registering acoustic signals based on noises in the vicinity and a processing unit for reprocessing the registered signals in order to conduct a situation recognition. In this instance, the sensor is designed in such a manner that during operation of the sensor network it accesses the registered and/or reprocessed signals from one or more adjacent sensors by way of a communication interface, and takes these signals into account for the situation recognition, whereby an adjacent sensor registers signals which are based at least in part on the same noises as the signals registered by the respective sensor.

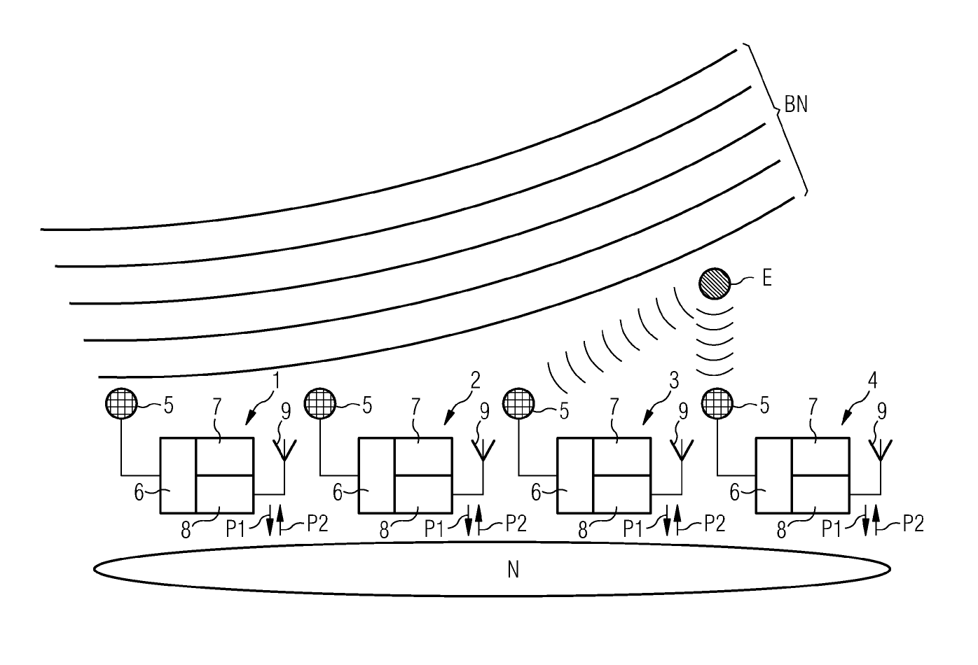

In order to monitor a vicinity, in the exemplary embodiment illustrated in FIG. 1 a sensor network using a plurality of sensors is provided, whereby the sensors 1, 2, 3 and 4 are depicted by way of example. Each of these sensors comprises an acquisition unit in the form of a microphone 5 for registering acoustic signals and a corresponding analog-to-digital converter 6 which converts the signals registered in analog fashion by way of the microphone into digitized signals. These digitized signals are processed by a microprocessor 7, whereby this microprocessor also takes into account signals from further adjacent sensors during the processing, as will be described in more detail in the following.

The individual sensors 1 to 4 communicate wirelessly with one another, whereby to this end each sensor has a corresponding radio module 8 which receives or transmits signals wirelessly by way of an antenna 9 shown schematically. In total the sensors form a decentralized network N which is indicated schematically by a corresponding ellipse. In the embodiment shown in FIG. 1 this decentralized network is a peer-to-peer network in which each sensor constitutes a corresponding peer in the network and in which the individual sensors communicate with one another by way of a peer-to-peer protocol. The communication between the sensors thus takes place decentrally, in other words the individual sensors exchange data directly with one another without the intermediary of a central point. The communication between the individual sensors over the network N is indicated in FIG. 1 for each sensor by means of corresponding arrows P1 and P2. The Chord protocol known sufficiently from the prior art can, for example, be used as the protocol for the peer-to-peer network.

The use of a peer-to-peer network has the advantage that it is possible to achieve self-organization and self-configuration of the sensor network on the basis of known protocols. Furthermore, peer-to-peer networks are very robust and enable the network to be easily expanded with newly added sensors or enable suitable adaptation of the network if sensors drop out. Instead of peer-to-peer mechanisms for forming the decentralized network, it is also possible where applicable to use other methods known from the prior art for forming such networks. For example, the sensors can be organized as a so-called ad-hoc network in which the sensors constitute nodes in a meshed network without a central management node. Such ad-hoc networks can independently establish and configure themselves between the individual sensors, as a result of which by analogy with peer-to-peer networks a dynamic modification and adaptation of the network are enabled if sensors are added or drop out. Ad-hoc networks and corresponding routing protocols for these networks are sufficiently known from the prior art, for example containing wireless communication protocols such as IEEE 802.11 (WLAN) or ad-hoc modes corresponding to IEEE 802.15.

In the sensor network shown in FIG. 1, a deviation from a normal state of the soundscape should be efficiently recognized on the basis of acoustically registered noises from the vicinity in order to recognize exceptional situations in this manner. In this instance, the sensor network is suited in particular for deployment in large-scale public areas, such as for example in stadiums, stations and the like. In this case, in each of the individual sensors 1 to 4 a corresponding situation recognizer is provided, by means of which situations deviating from the normal state can be recognized. In FIG. 1, the normal state of the soundscape is depicted by schematically indicated sound waves BN (BN=background noise) in the form of long concentric segments of a circle. In addition in FIG. 1, a conspicuous sound event E is represented by a black circle, from which noises emanate, which are indicated by means of concentric, short segments of a circle.

The situation recognizer is implemented in the individual sensors as a program which is executed by the microprocessor 7. In contrast to known situation recognizers, the situation recognizer of a respective sensor no longer processes only the signals registered by the sensor and where applicable reprocessed, but also corresponding signals which originate from other sensors in the network that are situated adjacent to the sensor under consideration. In this instance, a sensor is adjacent to another sensor if both sensors at least in part register the same noises. This can be made possible for example by the specification of a predefined minimum distance between adjacent sensors, whereby in this case information regarding their position is exchanged between the sensors which means that each sensor is able to ascertain the distance to other sensors. Where applicable, the network can already be constructed such as to ensure that each sensor is adjacent to another sensor in the network. In this case, with regard to the situation recognition, one sensor can also process the signals from all other sensors without itself needing to ensure that the processed signals at least in part also originate from adjacent sensors. Due to the fact that the noises from adjacent sensors are also taken into account by way of a decentralized communication between sensors, the situation recognition in the individual sensors can be significantly improved. In this instance, known methods can be employed in order to conduct the situation recognition on the basis of the acoustic signals from the respective sensor and its adjacent sensors.

In the network shown in FIG. 1 the noise signals registered by way of the microphone 5 are first digitized by the A/D converter 6 and segmented into time periods of fixed length (so-called frames). In this instance, there exists in particular the possibility of combining with one another the signals from the microphones of a plurality of adjacent sensors by means of a so-called beamforming algorithm which is already known. With regard to beamforming, the signals from the individual microphones of the sensors are correlated with one another in time-shifted fashion by means of appropriate control in order to thereby localize sound sources in predetermined directions. In this instance, by means of a corresponding exchange of information between the sensors, the sensors are coordinated with one another in such a manner that the microphones of adjacent sensors listen in a specific direction. The use of a beamforming algorithm is expedient in particular when it is known from which approximate direction noise signals that characterize exceptional situations are to be expected.

Furthermore, beamforming can be utilized in order to listen continuously in different directions in the space in order to thereby localize the position of conspicuous sound sources or to track these sound sources. As a result of the beamforming algorithm a better separation of the wanted signals from the background noises is thereby made possible. The beamforming algorithm just described can where applicable also be employed in the sensor network according to various embodiments for a plurality of microphones of an individual sensor.

In a variant of the vicinity monitoring system, the signals exchanged between adjacent sensors are used for improved noise suppression. In this instance, the sensors exchange the registered and digitized noise signals directly, whereby each sensor employs a correlation analysis to chronologically coordinate the signals registered by itself and the signals from the adjacent sensors and combine them such that the signal-to-noise ratio is improved. In this manner, noise-reduced signals which enable a better situation recognition are processed in the respective sensor.

In a further variant of the method, signals, already reprocessed from the original noise signals, from a plurality of sensors are taken into account in a sensor for situation recognition. In this instance, a situation recognizer of a respective sensor firstly employs already known methods to extract corresponding features from the noise signals. In a simple variant, such features are for example the volume of the noise signals. By preference, however, cepstral features are extracted which represent the volume distribution of the noise signals over their frequency, or modulation spectral features which represent the change in the volume of the noise signals over time. Multiband modulation spectra which represent the change in the volume over time for different frequencies of the registered noise signals can likewise be taken into account as features.

The processing of the extracted features takes place using methods sufficiently known from the prior art for the analysis of noise signals. By particular preference in this instance, data-based models are employed which have been learned or trained in advance using corresponding training signals. In this instance, in an initialization phase the sensors firstly exchange with one another the respective features ascertained by each of them. A respective sensor then determines a normal state of the soundscape with reference to the features ascertained by said sensor itself and originating from the adjacent sensors. In a simple variant wherein the feature is represented by the volume, the normal state can in this instance for example be represented by a simple threshold value, whereby the normal state then pertains if the signal lies below the threshold value.

With regard to the description of the noise signal through more complex features, in particular in the form of multidimensional feature vectors, more elaborate methods are employed in order to ascertain a normal state which in this case consists of a statistical distribution of the features of the noise signal. Known models by means of which a corresponding normal state can be determined are in this instance hidden Markov models, Gaussian mixture models, one-class support vector machines, neural networks and the like. With these models, after the determination of the normal state the signals generated during the noise monitoring are then also correspondingly analyzed in order to thereby detect a deviation from the normal state. In this instance, the individual sensors each continuously compare the currently ascertained feature vectors with the statistical model of the normal state in order to ascertain the probability of an exceptional state deviating from this normal state. If this probability exceeds a specific threshold value, an anomaly is detected.

When an anomaly is detected by a respective sensor, in a variant said sensor sends a corresponding warning message to a central point. For this purpose the sensor can have a separate communication interface. The warning can however also take place by way of the radio module of the corresponding sensor. In this instance, the central point is known to each sensor but does not constitute part of the decentralized network formed by the sensors. The central point can for example be a control center which is manned by an operator who can initiate specific actions when a corresponding warning message is sent. For example, the operator can specifically analyze the area again at which the sensor sending the warning is positioned. For this purpose, corresponding cameras which send images to the central control center can be positioned in the vicinity to be monitored. After receiving a warning message from a sensor the operator can then use the image from the corresponding camera in the area of the sensor to check whether an exceptional situation actually exists which renders further measures necessary.

With regard to the variant described above which employs data-based models for situation recognition, it is in particular not necessary for an abnormal sound event, which is to be identified accordingly, to be trained prior thereto. Rather, a conspicuous situation is recognized when the noise deviates greatly from the previously trained normal state. In an embodiment, in this instance the normal state is continuously adapted to the soundscape which may be changing, whereby again the data from not only one sensor but from a plurality of adjacent sensors is taken into account for the adaptation. By this means, a slow rise in the background noise level is not interpreted as an incident but only the deviations from the background noise are actually detected.

The embodiment of the method described above has a number of advantages. In particular, an improved situation recognition in an acoustic sensor network is ensured by the fact that each sensor also processes the noise signals from adjacent sensors. In this instance, a faster and more efficient data exchange is ensured by the fact that the individual sensors communicate with one another decentrally by way of a corresponding network. Proven technologies such as peer-to-peer networks or ad-hoc networks can be used for the decentralized communication. The use of decentralized networks for the communication between the sensors has the further advantage that these networks adapt themselves dynamically to changing circumstances in the network, in other words to newly added sensors or to dropped sensors. Continuous situation recognition is thereby ensured even if there is a change in the topology of the decentralized network. Furthermore, decentralized networks have the advantage that they are easy and cost-effective to install.

What is claimed is:

1. A method for monitoring a vicinity using a plurality of acoustic sensors, which form a decentralized network in which the sensors communicate with one another at least in part, the method comprising:
registering by each sensors acoustic signals which are based on noises in the vicinity, and reprocessing the registered signals in order to conduct a situation recognition,
accessing by a respective sensor of at least some of the sensors, by way of the decentralized network, the registered and/or reprocessed signals from one or more adjacent sensors and taking these signals into account for the situation recognition, and
registering by an adjacent sensor signals which are based at least in part on the same noises as the signals registered by the respective sensor.

2. The method according to claim 1, wherein the plurality of sensors form a peer-to-peer network, whereby each sensor constitutes a peer in this network.

3. The method according to claim 1, wherein the plurality of sensors forms a wireless radio network whereby the sensors each comprise a radio module for receiving and transmitting wireless signals in the radio network.

4. The method according to claim 1, wherein a respective sensor of at least some of the sensors ascertains an adjacent sensor in accordance with one or more predefined adjacency criteria.

5. The method according to claim 3, wherein the predefined adjacency criterion or criteria are given by the fact that two sensors are classed as adjacent if they are disposed in radio range of one another.

6. The method according to claim 4, wherein the adjacency criterion or criteria are given by a spatial distance between sensors, whereby two sensors are classed as adjacent if the spatial distance is less than or equal to a predetermined threshold, whereby the distances to at least some of other sensors in the decentralized network (N) are known to a respective sensor of at least some of the sensors.

7. The method according to claim 1, wherein a respective sensor of at least some of the sensors accesses the registered signals from the adjacent sensors and carries out a noise suppression by means of a correlation analysis of these signals and of the signals registered by said sensor.

8. The method according to claim 1, wherein a respective sensor of at least some of the sensors reprocesses the signals registered by said sensor in such a manner that it extracts one or more features from the registered signals, whereby with regard to the situation recognition the respective sensor takes into account the features extracted by said sensor and the features extracted by the adjacent sensors.

9. The method according to claim 1, wherein the extracted features are based on one or more of the following variables:
the volume of the registered signals;
the volume distribution over the frequency of the registered signals;
the change in the volume over time for one or more frequencies of the registered signals.

10. The method according to claim 1, wherein a respective sensor of at least some of the sensors uses a rule-based decision model for situation recognition.

11. The method according to claim 1, wherein a respective sensor of at least some of the sensors uses a data-based model for situation recognition.

12. The method according to claim 11, wherein the data-based model comprises at least one of a Hidden Markov model, a Gaussian mixture model, a support vector machine, and a neural network.

13. The method according to claim 11, whereby in an initialization phase a respective sensor of at least some of the sensors exchanges at least one of the registered signals and/or the reprocessed signals with the adjacent sensors and ascertains a normal state on the basis of these signals.

14. The method as claimed according to claim 8, wherein in an initialization phase a respective sensor of at least some of the sensors exchanges at least one of the registered signals and the reprocessed signals with the adjacent sensors and ascertains a normal state on the basis of these signals, and wherein the normal state is represented by a statistical distribution of extracted features.

15. The method according to claim 13, wherein a respective sensor of at least some of the sensors adapts the normal state during operation of the method depending on the signals registered by said sensor and the adjacent sensors.

16. The method according to claim 13, wherein one or more predetermined situations are defined by way of predetermined deviations from the normal state.

17. An acoustic sensor network for monitoring a vicinity, comprising a plurality of acoustic sensors, which form a decentralized network in which the sensors can communicate with one another at least in part, whereby the sensors each comprise an acquisition unit for registering acoustic signals based on noises in the vicinity, and a processing unit for reprocessing the registered signals in order to conduct a situation recognition, whereby a respective sensor of at least some of the sensors is designed in such a manner that it accesses the registered and/or reprocessed signals from one or more adjacent sensors by way of a communication interface and takes these signals into account for the situation recognition, whereby an adjacent sensor registers signals which are based at least in part on the same noises as the signals registered by the respective sensor.

18. The acoustic sensor network according to claim 17, wherein the plurality of sensors form a peer-to-peer network, whereby each sensor constitutes a peer in this network.

19. An acoustic sensor for use in an acoustic sensor network comprising an acquisition unit for registering acoustic signals based on noises in the vicinity, and a processing unit for reprocessing the registered signals in order to conduct a situation recognition, wherein by the sensor is designed in such a manner that during operation of the sensor network it accesses the registered and/or reprocessed signals from one or more adjacent sensors by way of a communication interface and takes these signals into account for the situation recognition, wherein an adjacent sensor registers signals which are based at least in part on the same noises as the signals registered by the respective sensor.

20. The method according to claim 3, wherein the a wireless radio network is an ad-hoc network.
